(19) United States
(12) Patent Application Publication
(10) Pub. No.: US 2017/0010350 A1
(43) Pub. Date: Jan. 12, 2017

(54) SYSTEMS AND METHODS FOR LOAD AWARE RADAR ALTIMETERS

(71) Applicant: Honeywell International Inc., Morristown, NJ (US)

(72) Inventor: Benjamin J. Winstead, Minneapolis, MN (US)

(21) Appl. No.: 14/796,120

(22) Filed: Jul. 10, 2015

(51) Int. Cl. G01S 13/88

(52) U.S. Cl. CPC G01S 13/882

(57) ABSTRACT

Systems and methods for load aware radar altimeters are provided. In one embodiment, a method for a load aware radar altimeter comprises: transmitting from a radar altimeter on an aircraft at least one RF radar pulse having a frequency of f₀; receiving a first return RF signal from a signal modifying target device attached to a load suspended below the aircraft, wherein the first return signal is a modified version of the at least one RF radar pulse; calculating a range from the aircraft to the signal modifying target device as a function of a propagation delay between transmitting the at least one RF radar pulse and receiving the first return RF signal; and desensitizing the radar altimeter to return RF signals having a frequency of f₀ within a load window calculated as a function of the range from the aircraft to the signal modifying target device.

### BACKGROUND

Radar altimeters are used on aircraft such as helicopters to determine the distance between the aircraft and the terrain over which it is flying. Radar altimeters will determine altitude based on the nearest target it can track. If a helicopter is carrying a slung load suspended below the helicopter, the load may present a trackable target to the radar altimeter. That is, as opposed to tracking the terrain, the radar altimeter will instead lock onto and track the slung load.

One proposed way to address this issue is to desensitize the radar altimeter so that it requires a stronger ground return signal for tracking If the load is small enough and relatively non-reflective then a desensitized radar altimeter may ignore the load and instead only track the terrain because the terrain is providing a stronger target. The problem with a desensitized radar altimeter is that its overall performance will also be reduced which may affect its performance in other applications. For example, a desensitized radar altimeter is more likely to break track when following a varying terrain, or to lock onto another reflective target at a father distance resulting in an erroneously high altitude determination.

Other options to address tracking the slung load is to move the location of the radar altimeter's transmitting and receiving antennas (such as to a boom extending from the front of the aircraft), or change the radar altimeter's antenna pattern so that there is less antenna gain in the direction of the load. However, it may be undesirable to add additional structures to facilitate moving the antennas. Further, adjusting the radar altimeter's antenna pattern complicates antenna design, especially given that a load may not remain in a static position with respect to the antenna during the course of a flight.

For the reasons stated above and for other reasons stated below which will become apparent to those skilled in the art upon reading and understanding the specification, there is a need in the art for systems and methods to provide load aware radar altimeters.

### SUMMARY

The Embodiments of the present invention provide methods and systems for load aware radar altimeters and will be understood by reading and studying the following specification.

Systems and methods for load aware radar altimeters are provided. In one embodiment, a method for a load aware radar altimeter comprises: transmitting from a radar altimeter on an aircraft at least one RF radar pulse having a frequency of f₀; receiving a first return RF signal from a signal modifying target device attached to a load suspended below the aircraft, wherein the first return signal is a modified version of the at least one RF radar pulse; calculating a range from the aircraft to the signal modifying target device as a function of a propagation delay between transmitting the at least one RF radar pulse and receiving the first return RF signal; and desensitizing the radar altimeter to return RF signals having a frequency of f₀ within a load window calculated as a function of the range from the aircraft to the signal modifying target device.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a radar altimeter system of one embodiment of the present disclosure;

FIGS. 2 and 3 are a block diagrams illustrating example implementations of a signal modifying radar target device of one embodiment of the present disclosure coupled to a cargo load;

FIG. 4 is a block diagram illustrating a radar altimeter of one embodiment of the present disclosure;

FIGS. 5 and 5A are diagrams illustrating a signal modifying radar target device of one embodiment of the present disclosure;

FIG. 6 is a diagram illustrating another signal modifying radar target device of one embodiment of the present disclosure; and

FIG. 7 is a flowchart illustrating a method of one embodiment of the present disclosure.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present disclosure address the problems of a cargo load interfering with the operation of a radar altimeter by introducing a target device that is attached to, or near, an under-aircraft carried cargo load and a radar altimeter that works in conjunction with the target device enabled to identify, and then ignore, the cargo load. More specifically, the target device is designed to return to the radar altimeter a modified version of a radar pulse received from the radar altimeter. The return signal is modified in a pre-determined fashion that is recognizable to the radar altimeter and distinguishable from a terrain reflected radar return signal. Therefore when such a modified return signal is received, the altimeter can determine a range from the aircraft to the cargo load, and then define a window around the cargo load in which it desensitizes. Radar return signals reflected from any object within this window will then be discounted, without desensitizing the altimeter to return signals received from the terrain.

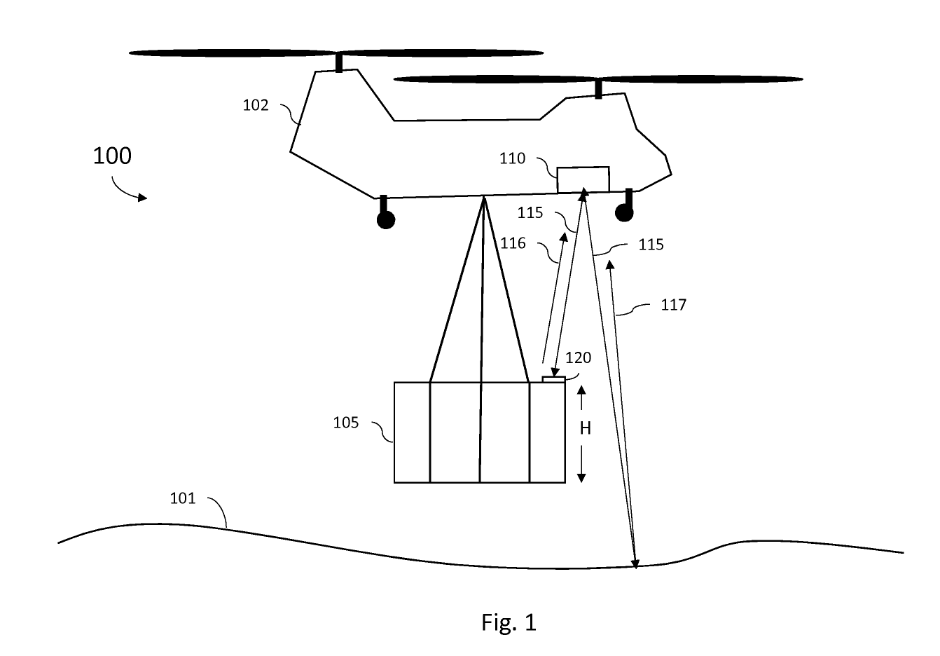

FIG. 1 is a block diagram illustrating a radar altimeter system 100 of one embodiment of the present disclosure. As shown in FIG. 1, an aircraft 102 is flying over a terrain 101. Although aircraft 102 is depicted as a helicopter, in other implementations of system 100, other forms of aircraft may be utilized. Also, terrain 101 may comprise a terrain of land, water, ice, or a combination thereof. A cargo load 105 comprises a slung load suspended under the aircraft 102. In some embodiments, cargo load 105 is suspended by fixed length cables. In other embodiments, cargo load 105 may be raised or lowered with respect to aircraft 102 (such as by a winch, for example). Radar altimeter system 100 itself comprises a radar altimeter 110 in combination with a signal modifying radar target device 120 that is coupled to the cargo load 105. In operation, radar altimeter 110 transmits towards terrain 101 a radar signal (shown at 115) that comprises at least one radio frequency (RF) radar pulse. Radar signal 115 is generated at a frequency of f₀, with a bandwidth of BW and duration (i.e. pulse width) of t_{pw}. A portion of that radar signal 115 will hit load 105 along with signal modifying radar target device 120, returning to radar altimeter system 100 a signal 116 comprising a reflected return signal component having a frequency of f₀, and a target device 120 generated return signal component having a frequency of f_{TDR}. In this embodiment, the target device 120 generated return component has a frequency f_{TDR} that is distinguishable by radar altimeter 110 from the load 105 reflected return component having a frequency of f₀. For example, in one implementation the frequency f_{TDR} is either twice, or some other integer multiple of frequency f₀. In this implementation, the bandwidth and pulse width of the target device 120 generated return component is the same as the originally transmitted radar signal 115.

When radar altimeter 110 receives the return signal 116, it recognizes the target device 120 generated return component having the frequency f_{TDR}. Based on the time delay between transmitting the radar signal 115 and receiving the modified return component from target device 120, radar altimeter 110 calculates a distance between the bottom of aircraft 102 and the target device 120. Radar altimeter 110 then desensitizes itself to return signals having frequency f₀ in the proximity of the target device 120. As such, when radar altimeter 110 subsequently receives a terrain 102 reflected return signal 117, radar altimeter 110 can lock on and track terrain 102 without interference from reflected return signals from load 105.

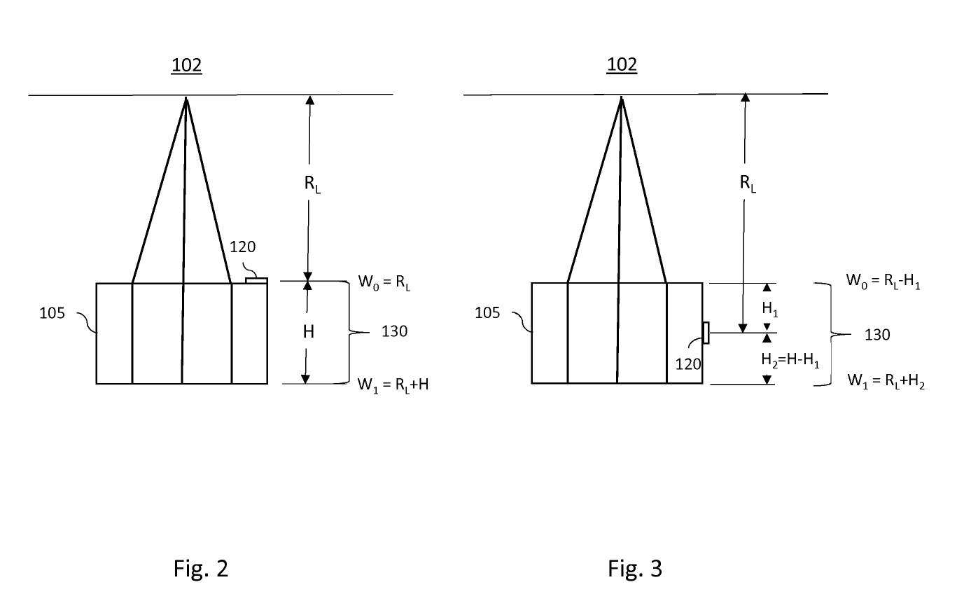

In one embodiment, radar altimeter 110 is configured to store data including the dimensions of load 105 (at least a height dimension H as shown in FIG. 1) and the relative placement of target device 120 on load 105 with respect to the height dimension H. Two such implementations are illustrated in FIGS. 2 and 3. For example, in one implementation shown in FIG. 2, the signal modifying radar target device 120 is secured to the top of cargo load 105, between cargo load 105 and aircraft 102. Based on the target device 120 generated return signal, radar altimeter 110 will determine a range to the load (R_{L}) and then calculate a load window 130 within which radar altimeter 110 will desensitize itself. Calculation of load window 130 will be a function of both the relative position of target device 120 with respect to the load 105 and height dimension H. In FIG. 2, because target device 120 is mounted to the top of load 105, load window 130 comprises an upper range W₀ even with the calculated range to the load R_{L}, and a lower range W₁ equal to the calculated range to the load R_{L} plus the height dimension H. Accordingly, radar altimeter 110 will desensitize itself to any return signal having frequency f₀ originating from the upper range W₀ to lower range W₁. FIG. 3 shows the more general case where the signal modifying radar target device 120 is secured at some arbitrary distance H₁ from the top of load 105, and a distance of H₂ from the bottom of load 105 (where H₁+H₂=H). In this case, the load window 130 upper range Wₒ is calculated by radar altimeter 110 by subtracting H₁ from R_{L}, and W₁ is calculated by radar altimeter 110 by adding H₂ to R_{L}. It should be appreciated that the upper and lower ranges W₀, W₁ may each include a tolerance factor such that the load window 130 is slightly larger that height dimension H.

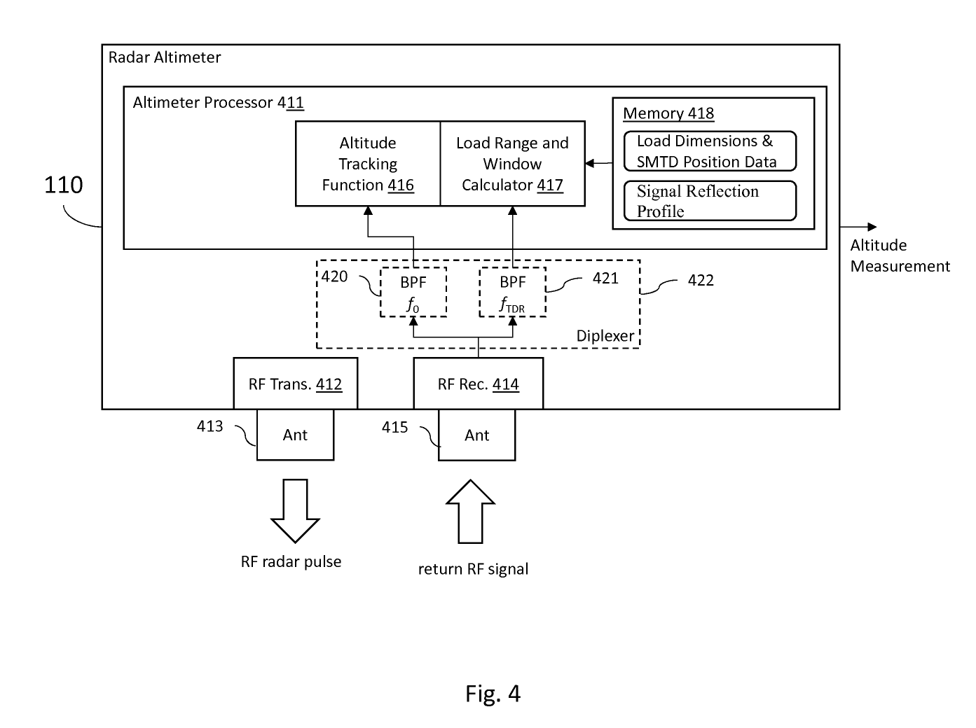

FIG. 4 is a block diagram illustrating one implementation of radar altimeter 110 for one embodiment of the present disclosure. In the implementation shown in FIG. 4, radar altimeter 110 comprises an RF transmitter 412 coupled to transmit antenna 413 and an RF receiver 414 coupled to a receive antenna 415. In some embodiments, transmit antenna 413 and receive antenna 415 may be implemented as a single antenna used for both transmitting and receiving. Radar altimeter 110 further comprises an altimeter processor 411 that includes an altitude tracking function 416 and a load range and window calculator 417. The load range and window calculator 417 is the component that processes the target device 120 generated return signal having the frequency of f_{TDR}. Based on the time delay between transmitting the radar signal 115 and receiving the f_{TDR} frequency return signal from target device 120, load range and window calculator 417 calculates the range (R_{L}) to the target device 120. The upper and lower ranges W₀ and W₁ are then calculated for load window 130 using load dimension (H) and the target device relative position data (e.g. H₁ and/or H₂) discussed with respect to FIGS. 2 and 3. The load dimension and the target device relative position data may be stored in a memory 418. In one implementation, the load dimension and target device position data may be measured and entered into memory 418 by a user, for example, prior to aircraft 102 departing with load 105. Once the upper and lower ranges W₀ and W₁ of load window 130 are determined, the altitude tracking function 416 is desensitized to tracking f₀ frequency return signals within the load window 130. Then based on tracking the f₀ frequency return signals received from outside load window 130, altitude tracking function 416 calculates and outputs a range measurement indicating the altitude of aircraft 102 above terrain 101. These range measurements may be calculated as a function of the time delay between transmitting the radar signal 115 and receiving the terrain reflected return signal using any means known to those of skill in the art. Because the relative position of load 105 with respect to aircraft 102 may change over the course of a flight, determining the position of load window 130 may be performed on a repeating basis. In one embodiment, the position of load window 130 is recalculated (and radar altimeter 110 desensitized accordingly) for every RF radar signal 115 transmitted. In some embodiments, radar altimeter 110 may optionally further comprise one or both of band pass filters 420 and 421. In one embodiment, band pass filter 420 comprises a f₀ frequency centered filter having a pass band of bandwidth BW (or otherwise determined based on bandwidth BW). Similarly, in one embodiment, band pass filter 421 comprises an f_{TDR} frequency centered filter having a pass band of bandwidth BW (or otherwise determined based on bandwidth BW). Band pass filters 420 and 421 serve the purpose of filtering unwanted signals from the inputs of altitude tracking function 416 and load range and window calculator 417, respectively. In some embodiments, when the frequencies f₀ and f_{TDR} are sufficiently spaced so that the bands of the reflected return signal and the target device generated return signal do not overlap, radar altimeter 110 may instead optionally comprise a diplexer 422 coupled between RF receiver 414 and altimeter processor 411 to take the place of band pass filters 420 and 421.

In one embodiment, memory 418 may further include a signal reflection profile for load 105, which in one implementation may be generated based on empirical reflection data for load collected by radar altimeter 110. Given the reflection characteristic of load 105 as described by the signal reflection profile, the degree of desensitization of radar altimeter 110 within load window 130 may be limited so that altimeter sensitivity is only reduced in that range an amount necessary to prevent radar altimeter 110 from locking onto and tracking load 105. That way, if an object that produces much stronger signal reflections than load 105 unexpectedly enters into the load window 130, radar altimeter 110 may be able to recognize the presence of this unexpected object and provide a range measurement to the object to the aircraft 102 flight crew despite desensitization of radar altimeter 110 to load 105.

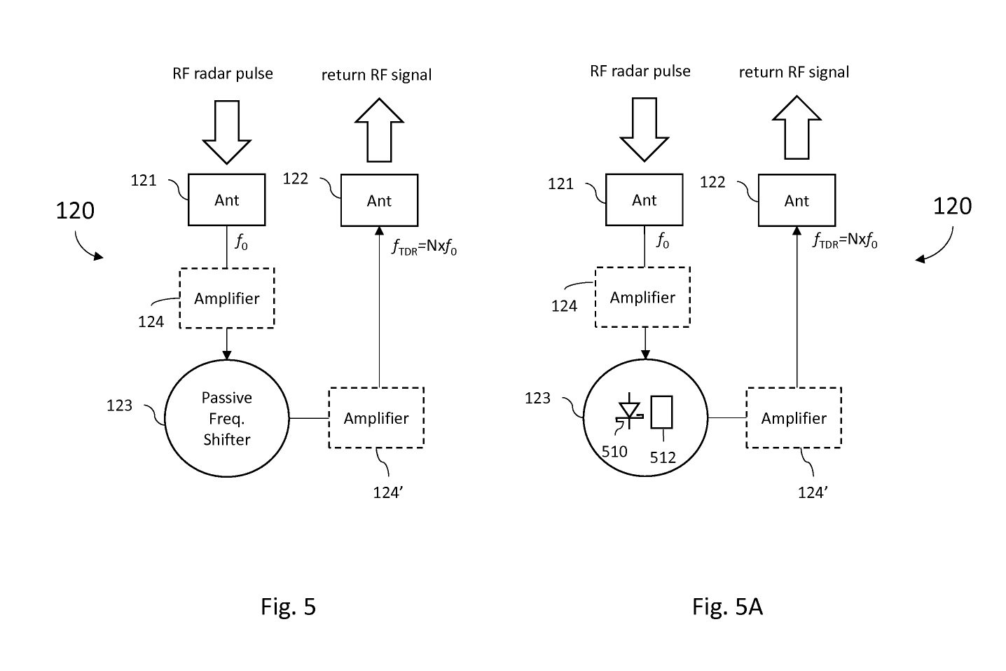

FIG. 5 is a block diagram illustrating one implementation of signal modifying radar target device 120 for one embodiment of the present disclosure. In the implementation shown in FIG. 5, signal modifying radar target device 120 comprises a receiving antenna 121 and a transmitting antenna 122 each coupled to a passive frequency shifter 123. One or both of receiving antenna 121 and transmitting antenna 122 may be implemented using a patch antenna. Receiving antenna 121 and transmitting antenna 122 may also optionally be combined and implemented using a single antenna, which may also be a patch antenna. Passive frequency shifter 123 employees a frequency shifting scheme which is configured to operate at high frequencies (such as RF frequencies used for radar applications). In one embodiment, passive frequency shifter 123 operates on a radar signal 115 received at antenna 121 to double its f₀ frequency and retransmit the f_{TDR}=2f₀ modified signal back to radar altimeter 110 via antenna 122. In other implementations, passive frequency shifter 123 may shift the f₀ frequency of the radar signal 115 to another integer multiple, N, of f₀ (such as N=3, 4, 5 . . . for example). However, it should be appreciated that return signal power is maximized using an integer multiple of N=2. In one embodiment, frequency shifting performed by passive frequency shifter 123 is implemented through a diode such as Schottky diode 510 as shown in FIG. 5A. Schottky diode 510 is a nonlinear circuit device able to generate an output signal with frequencies at integer multiples of the input frequency. In one embodiment, antenna 121 is configured or otherwise tuned to have a resonance frequency sensitive to f₀ while antenna 121 is configured or otherwise tuned to have a resonance frequency sensitive to f_{TDR}. In some implementations, passive frequency shifter 123 may further comprise a matching network 512 between antennas 121 and 122. The purpose of matching network 512 is to maximize the output power to antenna 122. Because signal modifying radar target device 120 as implemented in FIGS. 5 and 5A is a passive device, no external power is required to operate the device. Power is instead captured from the received radar signal 115 to operate passive frequency shifter 123.

In one embodiment, the output of passive frequency shifter 123 may be amplified using amplifier if the signal power output of passive frequency shifter 123 is deemed too weak for a particular application. Because this amplifier may be an active device, in an embodiment using the optional amplifier, a power source other than received radar signal 115 may be needed (such as a battery or photovoltaic device, for example). In one embodiment, the amplifier may be located before the frequency shifter such as illustrated by amplifier124 which can improve the signal-to-noise ratio (SNR). However, in other embodiments, the order of the components may be modified to instead locate the amplifier after the frequency shifter such as illustrated by amplifier 124′ depending on the requirements of the particular scenario, such as expected signal level at antenna 121, the required signal level from 122, and characteristics of the components of passive frequency shifter 123.

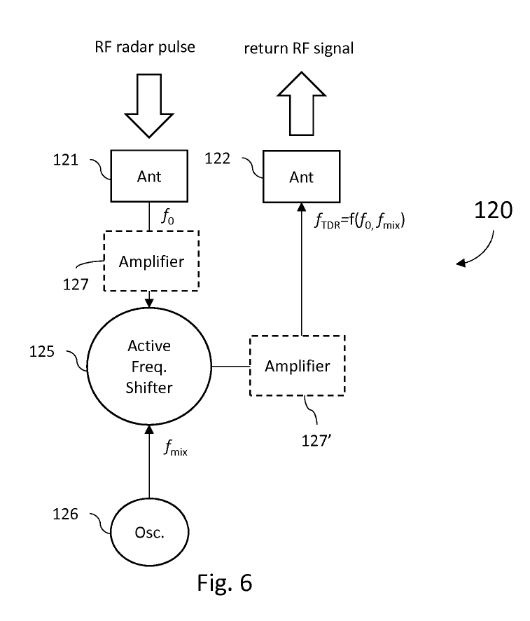

FIG. 6 is a block diagram illustrating an alternate implementation of a signal modifying radar target device 120 for one embodiment of the present disclosure. In FIG. 6, signal modifying radar target device 120 is identical to that shown in FIG. 5 except that passive frequency shifter 123 is replaced by an active frequency shifter 125 in combination with an oscillator 126. Active frequency shifter 125 operates on a radar signal 115 received at antenna 121 to modify its f₀ frequency and retransmit the f_{TDR} modified signal back to radar altimeter 110 via antenna 122. In one embodiment, active frequency shifter 125 comprises a mixer where the f₀ frequency radar signal 115 is mixed with an fₘᵢₓ frequency reference signal from oscillator 126 to output a modified return signal having a frequency of f_{TDR}=f₀+fₘᵢₓ. In such an embodiment, the frequency fₘᵢₓ should be selected such that the bandwidth of the modified return signal does not overlap in frequency with the bandwidth of the original radar signal 115. In one embodiment, the output of active frequency shifter 125 may be amplified using an (such as shown by amplifier 127 or alternately by amplifier 127′) if the signal power output of active frequency shifter 125 is deemed too weak for a particular application.

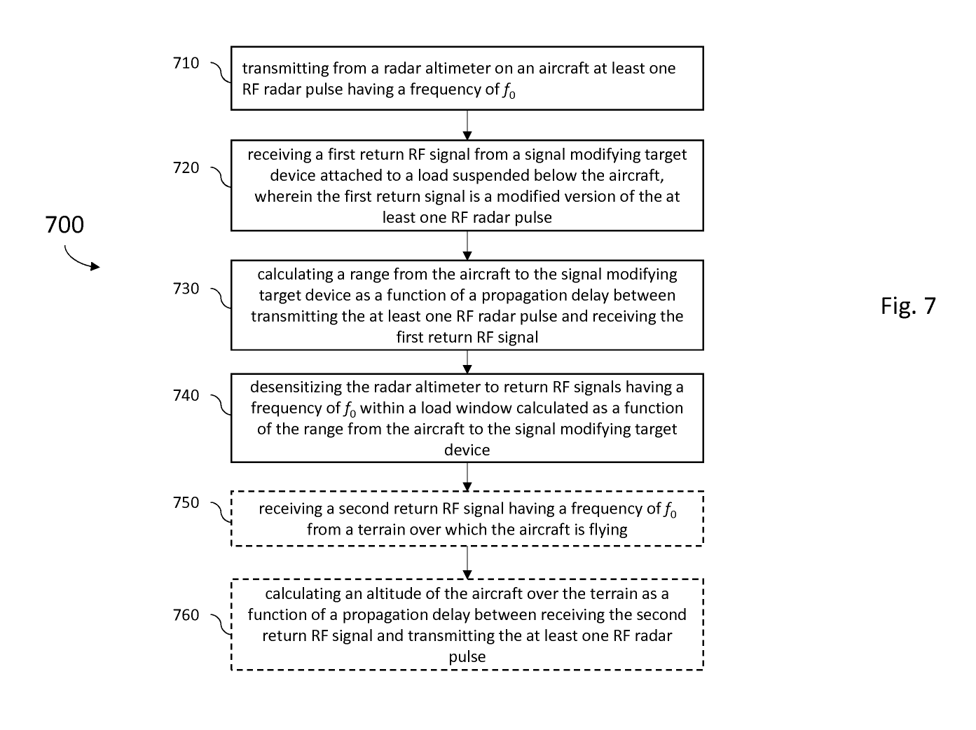

FIG. 7 is a flowchart illustrating a method 700 of one embodiment of the present disclosure. In some embodiments, method 700 may in whole or in part be implemented in combination or conjunction with any implementation or embodiment of radar altimeter system 100 as described with respect to FIGS. 1-6 above. Method 700 begins at 710 with transmitting from a radar altimeter on an aircraft at least one RF radar pulse having a frequency of f₀ and proceeds to 720 with receiving a first return RF signal from a signal modifying target device attached to a load suspended below the aircraft, wherein the first return signal is a modified version of the at least one RF radar pulse. In one embodiment, the first return signal has the same bandwidth and pulse width as the original RF radar pulse transmitted by the radar altimeter, but is frequency shifted to a frequency of f_{TDR}.

In some implementation of method 700, the signal modifying target device used in block 720 is as described with respect to FIGS. 5 and 5A and comprises a passive frequency shifter such as a Schottky diode or similar non-linear circuit device. In one such embodiment, the signal modifying target device operates on the at least one RF radar pulse received at is antenna to shift the f₀ frequency of the RF radar pulse to an integer multiple, N, of f₀ (such as N=2, 3, 4, 5 . . . for example). In other embodiments, the signal modifying target device used at block 720 is as described with respect to FIG. 6 and comprises an active frequency shifter. In that case the signal modifying target device operates on the at least one RF radar pulse received at its antenna to shift the f₀ frequency of the RF radar pulse to a frequency of f_{TDR} that is not necessarily an integer multiple of f₀. Here, method 500 at block 720 may further comprise mixing the f₀ frequency RF radar pulse with an fₘᵢₓ frequency reference signal to output the first return signal at frequency of f_{TDR}=f₀+fₘᵢₓ. In such an embodiment, the frequency f_{m ix} should be selected such that the bandwidth of the modified return signal does not overlap in frequency with the bandwidth of the RF radar pulse.

The method proceeds to 730 with calculating a range from the aircraft to the signal modifying target device as a function of a propagation delay between transmitting the at least one RF radar pulse and receiving the first return RF signal. In other words, based on the time delay between transmitting the RF radar pulse and receiving the first return signal generated by the signal modifying target device, the radar altimeter calculates a distance (introduced above as R_{L}) between the bottom of the aircraft and the target device.

The method next proceeds to 740 with desensitizing the radar altimeter to return RF signals having a frequency of f₀ within a load window calculated as a function of the range from the aircraft to the signal modifying target device. The load window may be calculated based on knowledge of the height dimension H of the load and the relative position of the signal modifying target device with respect to the load in the manner described above in FIGS. 3 and 4 to calculate load window 130. In some embodiments, the load window is defined in terms of an upper range W₀ and a lower range W₁ that envelop the position of the load so that the radar altimeter is desensitized at block 740 to return RF signals having a frequency of f₀ that originate from a range of W₀ to W₁ below the aircraft. Blocks 710 to 740 may then be repeated on an on-going basis to continuously adjust the load window and desensitize the radar altimeter to reflected radar returns from within that range accordingly.

With the radar altimeter now desensitized to the load, when subsequently received return signals are reflected back from the terrain, it can lock on and track the terrain without interference from reflected return signals from the load. As such, the method 700 may next proceed to 750 with receiving a second return RF signal having a frequency of f₀ from a terrain over which the aircraft is flying and to 760 with calculating an altitude of the aircraft over the terrain as a function of a propagation delay between receiving the second return RF signal and transmitting the at least one RF radar pulse.

### Example Embodiments

Example 1 includes a load aware radar altimeter system, the system comprising: a radar altimeter onboard an aircraft, the radar altimeter having at least one antenna positioned to transmit towards a terrain over which the aircraft is traveling at least one RF radar pulse having a first frequency f₀; a signal modifying radar target device, wherein the signal modifying radar target device is configured to receive the at least one RF radar pulse and transmit back to the radar altimeter a first return signal, wherein the first return signal is a modified version of the at least one RF radar pulse; wherein the radar altimeter is configured to receive the first return signal, and calculate a load range from the aircraft to the signal modifying radar target device as a function of a propagation delay between receiving the first return signal and transmitting the at least one RF radar pulse; and wherein the radar altimeter is configured to reduce sensitivity to return RF signals having a frequency of f₀ within a load window calculated as a function of the load range from the aircraft to the signal modifying radar target device.

Example 2 includes the system of example 1, wherein the signal modifying radar target device is coupled to a cargo load hung below the aircraft.

Example 3 includes the system of any of examples 1-2, wherein the signal modifying radar target device comprises a passive frequency shifter that generates the first return signal using passive components wherein the first return signal is at a frequency f_{TDR} that is an integer multiple of the first frequency f₀.

Example 4 includes the system of example 3, wherein the signal modifying radar target device further comprises a transmitting antenna and a receiving antenna, wherein the passive frequency shifter comprises: a diode and an impedance network coupled between the transmitting antenna and the receiving antenna.

Example 5 includes the system of any of examples 1-4, wherein the signal modifying radar target device comprises an active frequency shifter comprising a mixer that mixes the at least one RF radar pulse with a reference signal having a frequency fₘᵢₓ to output the first return signal at a frequency of f_{TDR}.

Example 6 includes the system of any of examples 1-5, wherein the radar altimeter further comprises: an RF transmitter coupled to transmit antenna, wherein the at least one RF radar pulse having a first frequency f₀ is transmitted by the RF transmitter; an RF receiver coupled to a receive antenna; and an altimeter processor comprising: an altitude tracking function; and a load range and window calculator coupled to the altitude tracking function; and a memory storing a load dimension (H) and target device relative position data; wherein the load range and window calculator processes the first return signal as received by the RF receiver to determine the load range from the aircraft to the signal modifying radar target; wherein the load range and window calculator determines an upper range and a lower range of the load window based on the load dimension (H) and target device relative position data; and wherein the load range and window calculator adjusts the altitude tracking function to reduce sensitivity of the radar altimeter to return RF signals having a frequency of f₀ and reflected from objects between the upper range and the lower range.

Example 7 includes the system of example 6, wherein the load range and window calculator further includes a signal reflection profile of a cargo load, and wherein the load range and window calculator adjusts the sensitivity altitude tracking function based on the signal reflection profile.

Example 8 includes the system of any of examples 1-7, wherein the signal modifying radar target device comprises a non-linear passive component that frequency shifts the first return signal to a frequency that is an integer multiple of f₀ to generate the first return signal.

Example 9 includes the system of any of examples 1-8, wherein the radar altimeter is configured to receive a second return signal comprising a reflection of the at least one RF radar pulse by the terrain over which the aircraft is traveling; and wherein the radar altimeter calculates a range to the terrain as a function of a propagation delay between receiving the second return signal and transmitting the at least one RF radar pulse.

Example 10 includes a method for a load aware radar altimeter, the method comprising: transmitting from a radar altimeter on an aircraft at least one RF radar pulse having a frequency of f₀; receiving a first return RF signal from a signal modifying target device attached to a load suspended below the aircraft, wherein the first return signal is a modified version of the at least one RF radar pulse; calculating a range from the aircraft to the signal modifying target device as a function of a propagation delay between transmitting the at least one RF radar pulse and receiving the first return RF signal; and desensitizing the radar altimeter to return RF signals having a frequency of f₀ within a load window calculated as a function of the range from the aircraft to the signal modifying target device.

Example 11 includes the method of example 10, further comprising: receiving a second return RF signal having a frequency of f₀ from a terrain over which the aircraft is flying; and calculating an altitude of the aircraft over the terrain as a function of a propagation delay between receiving the second return RF signal and transmitting that at least one RF radar pulse.

Example 12 includes the method of any of examples 10-11, wherein receiving the first return RF signal from the signal modifying target device further comprises: receiving a signal at a frequency f_{TDR} that is an integer multiple of the first frequency f₀.

Example 13 includes the method of example 12, further comprising: generating the first return RF signal at the signal modifying target device by applying the at least one RF radar pulse to a passive frequency shifter.

Example 14 includes the method of example 13, wherein the signal modifying radar target device further comprises a transmitting antenna and a receiving antenna, wherein the passive frequency shifter comprises: a diode and an impedance network coupled between the transmitting antenna and the receiving antenna.

Example 15 includes the method of any of examples 10-14, wherein the signal modifying radar target device comprises an active frequency shifter comprising a mixer that mixes the at least one RF radar pulse with a reference signal having a frequency fₘᵢₓ to output the first return signal at a frequency of f_{TDR}.

Example 16 includes the method of any of examples 10-15, wherein desensitizing the radar altimeter further comprises adjusting the sensitivity of the radar altimeter to return RF signals having a frequency of f₀ within the load window based on a signal reflection profile of the load.

Example 17 includes the method of any of examples 10-16, wherein the signal modifying radar target device comprises a non-linear passive component that frequency shifts the first return signal to a frequency that is an integer multiple of f₀ to generate the first return signal.

Example 18 includes the method of any of examples 10-17, wherein the radar altimeter further comprises: an RF transmitter coupled to transmit antenna, wherein the at least one RF radar pulse having a first frequency f₀ is transmitted by the RF transmitter; an RF receiver coupled to a receive antenna; and an altimeter processor comprising: an altitude tracking function; a load range and window calculator coupled to the altitude tracking function; and a memory storing a load dimension (H) and target device relative position data.

Example 19 includes the method of example 18, further comprising the load range and window calculator determining the load range from the aircraft to the signal modifying radar target by processing the first return signal as received by the RF receiver; and the load range and window calculator determining an upper range and a lower range of the load window based on the load dimension (H) and target device relative position data.

Example 20 includes the method of example 19, further comprising: the load range and window calculator adjusting the altitude tracking function to reduce sensitivity of the radar altimeter to return RF signals having a frequency of f₀ and reflected from objects between the upper range and the lower range.

In various alternative embodiments, system elements, method steps, or examples described throughout this disclosure (such as the radar altimeter, the altimeter processor, the altitude tracking function, load range and window calculator, or sub-parts thereof, for example) may be implemented on one or more computer systems, field programmable gate arrays (FPGAs), or similar devices comprising a processor executing code to realize those elements, processes, or examples, said code stored on a non-transient data storage device. Therefore other embodiments of the present disclosure may include elements comprising program instructions resident on computer readable media which when implemented by such computer systems, enable them to implement the embodiments described herein. As used herein, the term “computer readable media” refers to tangible memory storage devices having non-transient physical forms. Such non-transient physical forms may include computer memory devices, such as but not limited to punch cards, magnetic disk or tape, any optical data storage system, flash read only memory (ROM), non-volatile ROM, programmable ROM (PROM), erasable-programmable ROM (E-PROM), random access memory (RAM), or any other form of permanent, semi-permanent, or temporary memory storage system or device having a physical, tangible form. Program instructions include, but are not limited to computer-executable instructions executed by computer system processors and hardware description languages such as Very High Speed Integrated Circuit (VHSIC) Hardware Description Language (VHDL).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A load aware radar altimeter system, the system comprising:
a radar altimeter onboard an aircraft, the radar altimeter having at least one antenna positioned to transmit towards a terrain over which the aircraft is traveling at least one RF radar pulse having a first frequency f₀;
a signal modifying radar target device, wherein the signal modifying radar target device is configured to receive the at least one RF radar pulse and transmit back to the radar altimeter a first return signal, wherein the first return signal is a modified version of the at least one RF radar pulse;
wherein the radar altimeter is configured to receive the first return signal, and calculate a load range from the aircraft to the signal modifying radar target device as a function of a propagation delay between receiving the first return signal and transmitting the at least one RF radar pulse; and
wherein the radar altimeter is configured to reduce sensitivity to return RF signals having a frequency of f₀ within a load window calculated as a function of the load range from the aircraft to the signal modifying radar target device.

2. The system of claim 1, wherein the signal modifying radar target device is coupled to a cargo load hung below the aircraft.

3. The system of claim 1, wherein the signal modifying radar target device comprises a passive frequency shifter that generates the first return signal using passive components wherein the first return signal is at a frequency f_{TDR} that is an integer multiple of the first frequency f₀.

4. The system of claim 3, wherein the signal modifying radar target device further comprises a transmitting antenna and a receiving antenna, wherein the passive frequency shifter comprises:
a diode and an impedance network coupled between the transmitting antenna and the receiving antenna.

5. The system of claim 1, wherein the signal modifying radar target device comprises an active frequency shifter comprising a mixer that mixes the at least one RF radar pulse with a reference signal having a frequency fₘᵢₓ to output the first return signal at a frequency of f_{TDR}.

6. The system of claim 1, wherein the radar altimeter further comprises:
an RF transmitter coupled to transmit antenna, wherein the at least one RF radar pulse having a first frequency f₀ is transmitted by the RF transmitter;
an RF receiver coupled to a receive antenna; and
an altimeter processor comprising:
an altitude tracking function; and
a load range and window calculator coupled to the altitude tracking function; and
a memory storing a load dimension (H) and target device relative position data;
wherein the load range and window calculator processes the first return signal as received by the RF receiver to determine the load range from the aircraft to the signal modifying radar target;
wherein the load range and window calculator determines an upper range and a lower range of the load window based on the load dimension (H) and target device relative position data; and
wherein the load range and window calculator adjusts the altitude tracking function to reduce sensitivity of the radar altimeter to return RF signals having a frequency of f₀ and reflected from objects between the upper range and the lower range.

7. The system of claim 6, wherein the load range and window calculator further includes a signal reflection profile of a cargo load, and wherein the load range and window calculator adjusts the sensitivity altitude tracking function based on the signal reflection profile.

8. The system of claim 1, wherein the signal modifying radar target device comprises a non-linear passive component that frequency shifts the first return signal to a frequency that is an integer multiple of fₒ to generate the first return signal.

9. The system of claim 1, wherein the radar altimeter is configured to receive a second return signal comprising a reflection of the at least one RF radar pulse by the terrain over which the aircraft is traveling; and
wherein the radar altimeter calculates a range to the terrain as a function of a propagation delay between receiving the second return signal and transmitting the at least one RF radar pulse.

10. A method for a load aware radar altimeter, the method comprising:
transmitting from a radar altimeter on an aircraft at least one RF radar pulse having a frequency of f₀;
receiving a first return RF signal from a signal modifying target device attached to a load suspended below the aircraft, wherein the first return signal is a modified version of the at least one RF radar pulse;
calculating a range from the aircraft to the signal modifying target device as a function of a propagation delay between transmitting the at least one RF radar pulse and receiving the first return RF signal; and
desensitizing the radar altimeter to return RF signals having a frequency of f₀ within a load window calculated as a function of the range from the aircraft to the signal modifying target device.

11. The method of claim 10, further comprising:
receiving a second return RF signal having a frequency of f₀ from a terrain over which the aircraft is flying; and
calculating an altitude of the aircraft over the terrain as a function of a propagation delay between receiving the second return RF signal and transmitting that at least one RF radar pulse.

12. The method of claim 10, wherein receiving the first return RF signal from the signal modifying target device further comprises:
receiving a signal at a frequency f_{TDR} that is an integer multiple of the first frequency f₀.

13. The method of claim 12, further comprising:
generating the first return RF signal at the signal modifying target device by applying the at least one RF radar pulse to a passive frequency shifter.

14. The method of claim 13, wherein the signal modifying radar target device further comprises a transmitting antenna and a receiving antenna, wherein the passive frequency shifter comprises:
a diode and an impedance network coupled between the transmitting antenna and the receiving antenna.

15. The method of claim 10, wherein the signal modifying radar target device comprises an active frequency shifter comprising a mixer that mixes the at least one RF radar pulse with a reference signal having a frequency fₘᵢₓ to output the first return signal at a frequency of f_{TDR}.

16. The method of claim 10, wherein desensitizing the radar altimeter further comprises adjusting the sensitivity of the radar altimeter to return RF signals having a frequency of f₀ within the load window based on a signal reflection profile of the load.

17. The method of claim 10, wherein the signal modifying radar target device comprises a non-linear passive component that frequency shifts the first return signal to a frequency that is an integer multiple of f₀ to generate the first return signal.

18. The method of claim 10, wherein the radar altimeter further comprises:
an RF transmitter coupled to transmit antenna, wherein the at least one RF radar pulse having a first frequency f₀ is transmitted by the RF transmitter;
an RF receiver coupled to a receive antenna; and
an altimeter processor comprising:
an altitude tracking function;
a load range and window calculator coupled to the altitude tracking function; and
a memory storing a load dimension (H) and target device relative position data.

19. The method of claim 18, further comprising the load range and window calculator determining the load range from the aircraft to the signal modifying radar target by processing the first return signal as received by the RF receiver; and
the load range and window calculator determining an upper range and a lower range of the load window based on the load dimension (H) and target device relative position data.

20. The method of claim 19, further comprising:
the load range and window calculator adjusting the altitude tracking function to reduce sensitivity of the radar altimeter to return RF signals having a frequency offo and reflected from objects between the upper range and the lower range.
